(19) United States
(12) Patent Application Publication
(10) Pub. No.: US 2023/0311968 A1
(43) Pub. Date: Oct. 5, 2023

(54) SHOPPING CART

(71) Applicant: WANZL GMBH & CO. KGAA, Leipheim (DE)

(72) Inventors: Tobias RUF, Burgau (DE); Michael KROENES, Burgau (DE); Johann DAMINGER, Burlafingen (DE); Thomas GASCHE, Leipheim (DE); Michael GAUCH, Stuttgart (DE)

(21) Appl. No.: 17/760,443

(22) PCT Filed: Feb. 12, 2021
(86) PCT No.: PCT/EP2021/053397

§ 371 Date: Aug. 9, 2022

(30) Foreign Application Priority Data
Feb. 13, 2020 (DE) 10 2020 103 760.0

(51) Int. Cl. B62B 5/06; B62B 3/14; B62B 5/00; G06Q 30/0601

(52) U.S. Cl. CPC B62B 5/06; B62B 3/1416; B62B 3/1424; G06Q 30/0633; B62B 5/0096; B62B 3/1472; B62B 3/1428

(57) ABSTRACT

The invention relates to a push handle unit of a shopping cart having at least one first and one second end piece, wherein a free-standing gripping unit which rises upward is arranged on at least one end piece, the gripping unit being designed as an object holder for receiving at least one beverage container and/or a scanner and/or a magnifier for enlarging text on a package and/or a handle cap and/or a smart phone.

### CROSS REFERENCE TO RELATED APPLICATIONS

The present application is a U.S. National Phase of International Application No. PCT/EP2021/053397 entitled “SHOPPING CART,” and filed on Feb. 12, 2021. International Application No. PCT/EP2021/053397 claims priority to German Patent Application No. 10 2020 103 760.0 filed on Feb. 13, 2020. The entire contents of each of the above-listed applications are hereby incorporated by reference for all purposes.

### TECHNICAL FIELD

The present invention relates to a scanner on a shopping cart serving the purpose of scanning and ultimately paying for goods bought by a user.

### BACKGROUND AND SUMMARY

In the prior art it is known to arrange a scanner on a shopping cart. By way of example, US 2011036907A discloses a scanner facing into the interior of a shopping cart. The goods received in the shopping cart can thereby be scanned automatically. CN 207931760U describes a shopping cart whose push handle unit has a scanner integrated therein. The document CN 208044661U discloses a movable scanner connected to the shopping cart via a cable.

In the case of the scanners for shopping carts in the prior art, it is always necessary to carry out costly and laborious conversion if conventional shopping carts are intended to be equipped with a scanner. As a result, the transition from conventional shopping carts to shopping carts having a scanner is associated with high costs.

Therefore, it is an object of the invention to provide a scanner for a shopping cart which enables a conventional shopping cart to be retrofitted rapidly and at low cost.

A first embodiment of the invention provides a push handle unit of a shopping cart having at least one first and one second end piece, wherein a free-standing, upwardly projecting gripping unit is arranged on at least one end piece, wherein the gripping unit is configured as an object holder for receiving at least one beverage cup and/or a scanner and/or a magnifying glass for magnifying text on a packaging and/or a handle cap and/or a smartphone.

The gripping unit of the shopping cart serves for comfortably gripping the push handle unit of a shopping cart. The arrangement of the object holder does not adversely affect the comfortable gripping of the push handle unit. Advantageously, however, additional objects or functional units can be fixed to the shopping cart and the user of the shopping cart therefore does not have to hold them by hand. A handle cap serves to close off the receptacle of the object holder if the object holder is not required for a magnifying glass or a scanner, for example.

A second embodiment of the invention provides a shopping cart having a push handle unit as claimed in any of claims 1 to 7.

A third embodiment of the invention provides a method for communication between a scanner of a push handle unit as claimed in any of claims 1 to 7 and a network and/or a smartphone.

Advantageously, the scanner of the shopping cart or of the push handle unit communicates with a network of a supermarket or of a financial service provider, as a result of which the products bought can be paid for automatically. Scanning at a checkout can thereby be rendered superfluous.

A fourth embodiment of the invention provides a computer program product comprising a software program for realizing a device for scanning packagings and for communication with a network and/or a smartphone, wherein the computer program product comprises a set having instructions that cause the method as claimed in claim 9 to be carried out.

A fifth embodiment of the invention provides a computer program that is distributable by electronic data transmission, having computer program code means adapted to have the effect that when the program is loaded onto a computer, the latter can carry out the procedure as claimed in claim 9.

Exemplary embodiments are described in the dependent claims.

One additionally exemplary embodiment of the invention provides a push handle unit having at least one first and one second end piece, wherein a free-standing, upwardly projecting gripping unit is arranged on at least one end piece, wherein the gripping unit is configured as an object holder for receiving at least one beverage cup or a scanner or a magnifying glass or a handle cap or a smartphone.

Advantageously, the object holder is configured in such a way that retrofitting is made possible. By way of example, if a shopping cart is initially equipped with a magnifying glass, the magnifying glass can be replaced by a scanner in a retrofitting process, as a result of which shopping without scanning at a central checkout is made possible in principle.

One exemplary embodiment of the invention provides a push handle unit, wherein a display unit for identifying a successful scanning process, in particular by way of a color change, is arranged on the scanner.

Simple identification of a successful scanning process in a manner that makes use of color enables simple and effective communication between the user of the shopping cart and the scanner, as a result of which the scanning process can be carried out efficiently.

A further embodiment according to the invention provides a push handle unit, wherein the push handle unit comprises a luminous display, wherein the luminous display is shaped in the manner of an arrow, wherein the arrow is configured so as to be pointing in the direction of the scanning region.

Advantageously, a luminous display can be arranged on the shopping cart, which luminous display firstly indicates for example by way of a color change that a scanning process was carried out successfully, and is additionally shaped in such a way that the user can recognize where the scanning region is, that is to say toward where he/she must hold out the packaging to be scanned or the product to be scanned in order that the scanning process can take place.

A further exemplary embodiment of the present invention provides a push handle unit, wherein the push handle unit is configured with a magnifying glass in a first state and the magnifying glass is replaceable or is replaced by a scanner in a second state.

A further embodiment according to the invention provides a push handle unit, wherein the scanner comprises a reading unit facing toward the shopping cart, thus resulting in a scanning region in the direction of the shopping cart.

A further exemplary embodiment of the present invention provides a push handle unit, wherein the smartphone and the scanner are connected to one another via WLAN or Bluetooth.

One concept of the invention can be considered that of enabling goods to be scanned by a stationary scanner arranged on the shopping cart. The scanning process can alternatively be effected by the user's smartphone if bulky or heavy goods, for example boxes of detergent, are to be scanned. The scanning unit on the shopping cart is autonomous and can comprise a display unit. The display unit can in particular notify the user that the scanning process was successful. The scanner or the scanning unit can be arranged in an object holder provided as an alternative to the object holder of a magnifying glass. As a result, shopping carts having a magnifying glass function can be retrofitted to a scanner. A further aspect of the invention is the connection of the scanner on the shopping cart to the user's smartphone or cell phone via WLAN or Bluetooth in order that communication can take place.

It goes without saying that the individual features can also be combined among one another, as a result of which advantageous effects that go beyond the sum of the individual effects can also be established in some instances.

### BRIEF DESCRIPTION OF THE FIGURES

Further details and advantages of the invention will become clear on the basis of the exemplary embodiments illustrated in the drawings, in which

FIG. 1 shows a system of smartphone 2 and scanner 1 on a shopping cart,

FIG. 2 shows a scanning process in which a scanner 1 scans a product,

FIG. 3 shows a push handle unit 5 of a shopping cart with an object holder 6,

FIG. 4 shows a shopping cart 3 in a perspective view with an object holder 6 for a magnifying glass or for a scanner or for a smartphone,

FIG. 5 shows the shopping cart 3 in a side view with push handle unit 5, on which the object holder 6 is integrated,

FIG. 6 shows the shopping cart 3 from the rear with the push handle unit 5 and the object holder 6,

FIG. 7 shows a push handle unit 5 of a shopping cart with an object holder 6,

FIG. 8 shows an object holder 6 for a magnifying glass or for a scanner that is additionally suitable for a smartphone or a cell phone,

FIG. 9 shows the object holder 6 with a smartphone 2 arranged therein,

FIG. 10 shows the scanner 1 according to the invention on a shopping cart,

FIG. 11 shows the scanner 1 with a reading unit 7,

FIG. 12 shows the scanner 1 in a plan view,

FIG. 13 shows the scanner 1,

FIG. 14 shows the scanner 1 in a side view,

FIG. 15 shows a part of the scanner 1 without the upper housing with an illustration of the internal elements of the scanner,

FIG. 16 shows the part of the scanner 1 in a lateral illustration with the reading unit 7,

FIG. 17 shows the part of the scanner 1 with a perspective illustration of the elements arranged in the interior,

FIG. 18 shows the elements of the scanner 1 arranged in the interior in a view from above,

FIG. 19 shows the elements arranged in the interior of the scanner 1 in a perspective view from above.

### DETAILED DESCRIPTION

FIG. 1 shows a shopping cart 3 with a scanner 1. The scanner 1 can communicate with a cell phone 2 via a Bluetooth connection, for example. In this case, an individual scanning process can be performed in particular by the cell phone 2 instead of by the scanner 1, since for example heavy goods can only be held in front of the scanner 1 in a laborious manner. Moreover, the goods bought can be listed on the cell phone 2 in order that the user can keep track of the goods that he/she has selected.

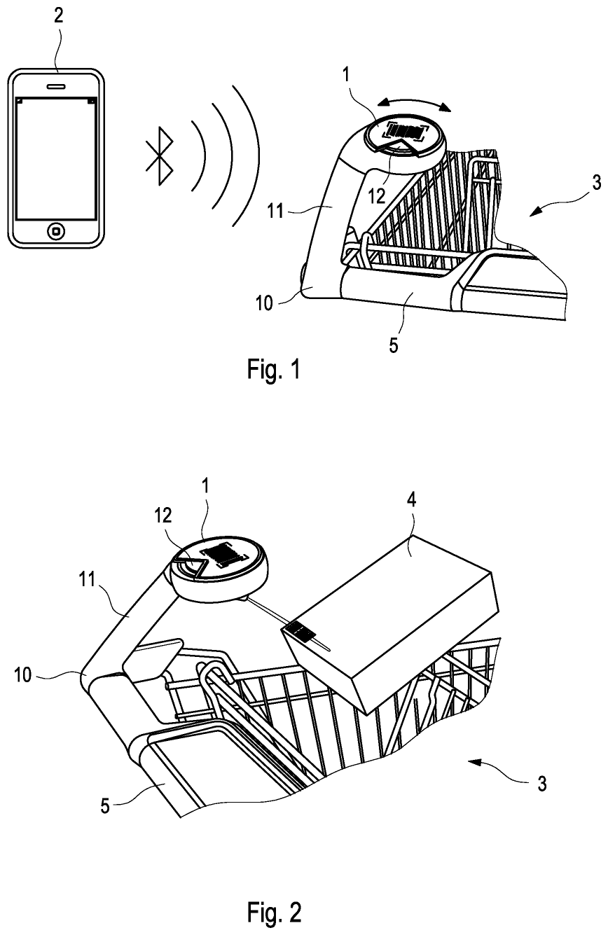

FIG. 2 shows the scanner 1 during the process of scanning a packaging 4. For this purpose, the user has to hold the packaging 4 in front of the scanner 1 in order to start a scanning process. The scanner 1 can comprise a display unit 12, which can indicate a successful scanning process by way of luminous signals, for example.

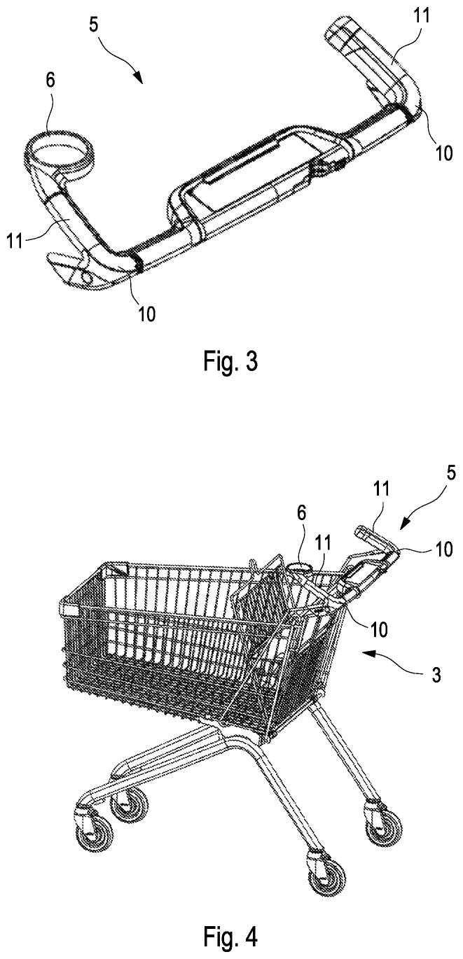

FIG. 3 shows a push handle unit 5 of a shopping cart with an object holder 6 for a magnifying glass. The object holder 6 can receive a scanner instead of a magnifying glass.

FIG. 4 shows a conventional shopping cart 3 with a push handle unit 5, comprising an object holder 6 for a magnifying glass.

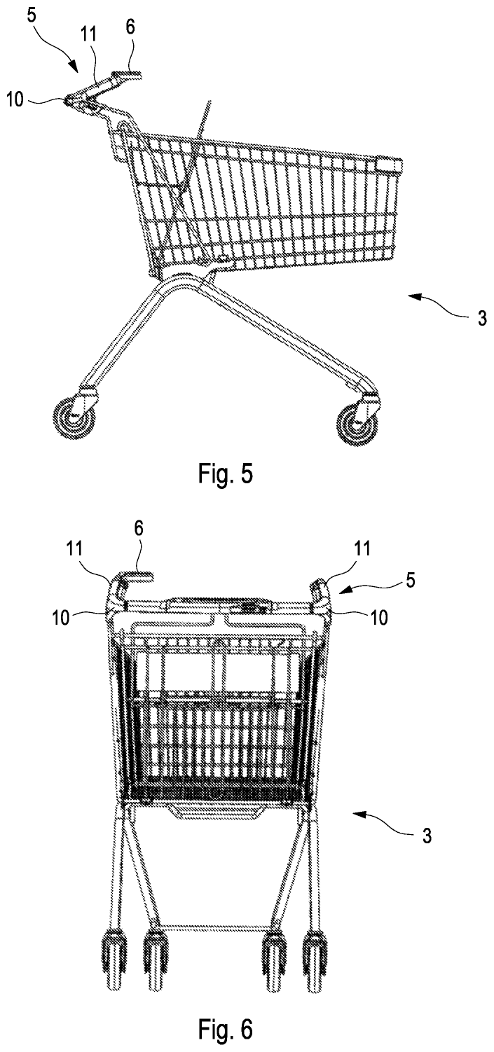

FIG. 5 shows the shopping cart 3 with the object holder 6 for a magnifying glass. The magnifying glass can be replaced by a scanner, as a result of which upgrading of a conventional shopping cart 3 without a scanning unit to a shopping cart with a scanner is made possible very rapidly and cost-effectively.

FIG. 6 shows the shopping cart 3 with the push handle unit 5, on which the object holder 6 for a magnifying glass or alternatively for a scanning unit is arranged.

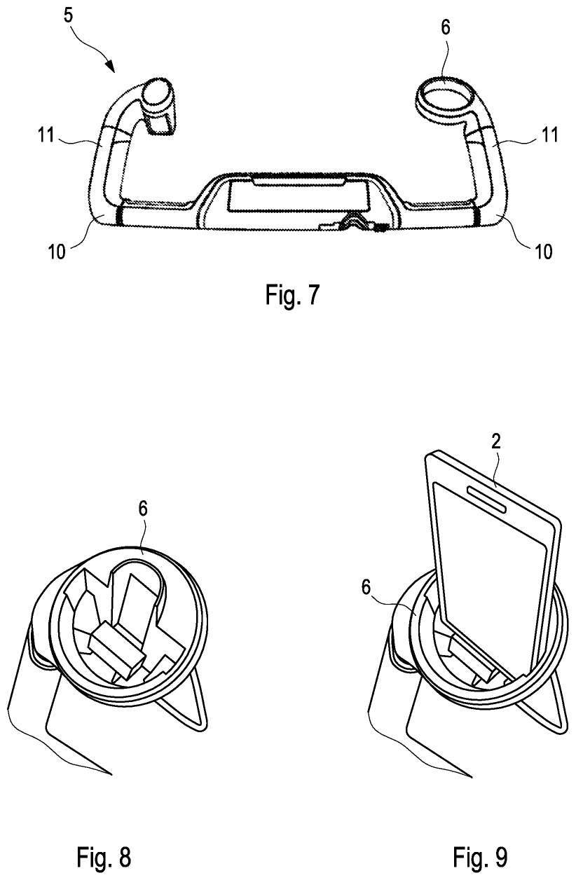

FIG. 7 shows a push handle unit 5 of a shopping cart, wherein the object holder 6 for a magnifying glass or alternatively for a scanner is arranged on the right-hand side.

FIG. 8 shows the object holder 6 for a magnifying glass or alternatively for a scanner, wherein the object holder 6 is equipped such that a smartphone can be connected to the object holder 6 and can thus be used as a mobile scanner.

FIG. 9 shows a smartphone 2 arranged in the object holder 6.

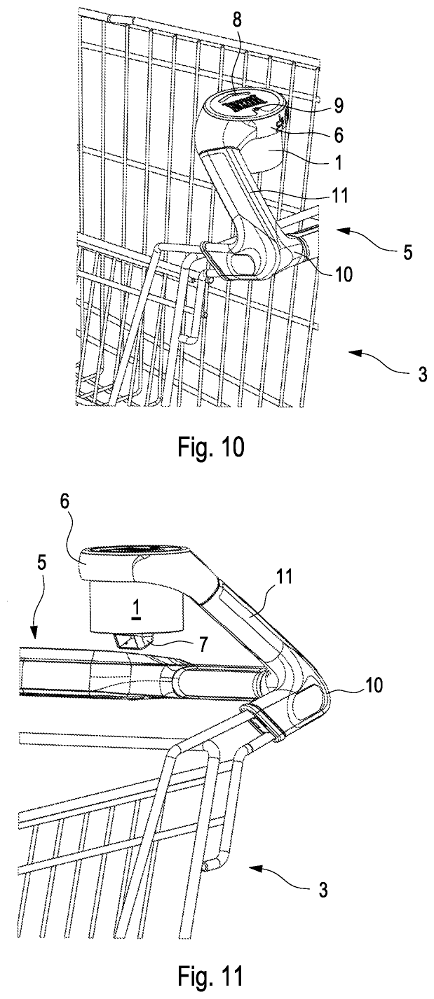

FIG. 10 shows a scanner 1 arranged on a shopping cart 3. The scanner 1 can comprise one or more display units 8 and 9 allowing communication with the user. By way of example, a luminous display 8 can be arranged which is permanently luminous with red light and is luminous with green light for a certain time period, for example two to three seconds, if a scanning process took place successfully. Moreover, a luminous unit 9 can be present which indicates the operational readiness. The scanner 1 is configured so as to be removable from the object holder 6, such that a magnifying glass can be inserted into the object holder 6 instead of the scanner 1. The scanner 1 can be configured as a 2D scanner for reading QR codes or 1D code EAN13. This is also intended to enable pairing, i.e. bonding, in order to establish a connection between computer devices in computer networks. The communication between the computer devices is thereby made possible. Pairing of the scanner 1 with the user's cellular phone can also take place.

In an alternative embodiment, the scanner 1 can automatically recognize a movement in its scanning region and then starts the scanning process. The data read in by the scanner 1, i.e. the codes of the goods packages, are transmitted via Bluetooth or WLAN, for example. Transmission to a server of the supermarket or department store and/or to the user's cell phone or smartphone can take place. The scanner 1 comprises a rechargeable battery for power supply.

FIG. 11 shows the scanning solution on the shopping cart 3 with the scanner 1 and the reading unit 7.

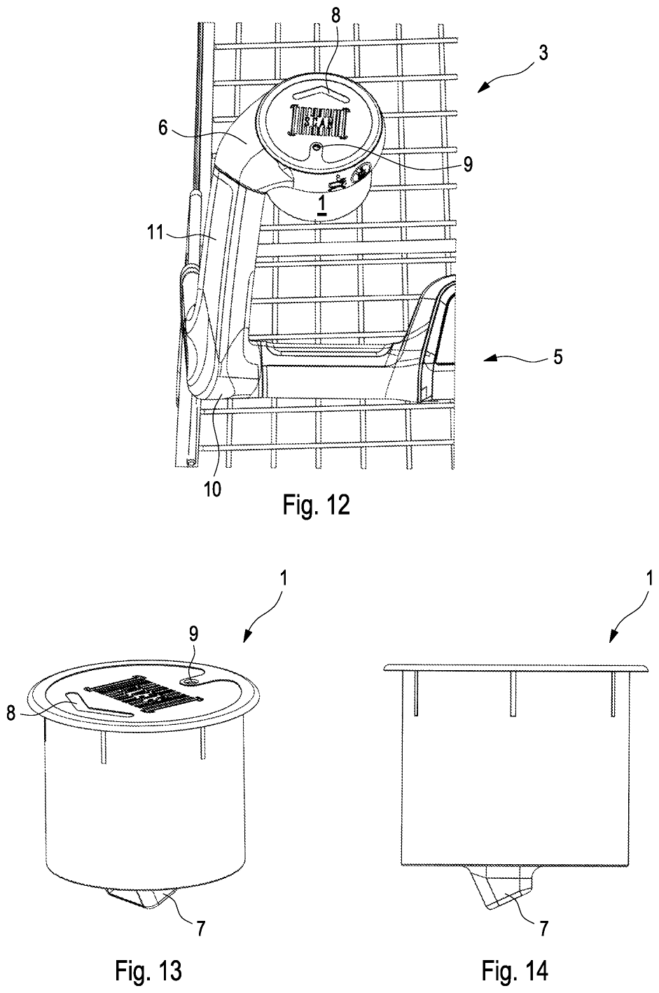

FIG. 12 shows the scanning solution on the shopping cart 3 in a plan view with the shopping cart 3 and the scanner 1, with the luminous displays 8 and 9. The luminous display 8 can have a particular configuration, for example as an indicated arrow in order to make it clear to the user how or where he/she should hold a product to be scanned in order that it can be scanned.

FIG. 13 shows the scanner 1 with the reading unit 7 and the luminous displays 8 and 9 in a perspective illustration.

FIG. 14 shows the scanner 1 in a lateral illustration.

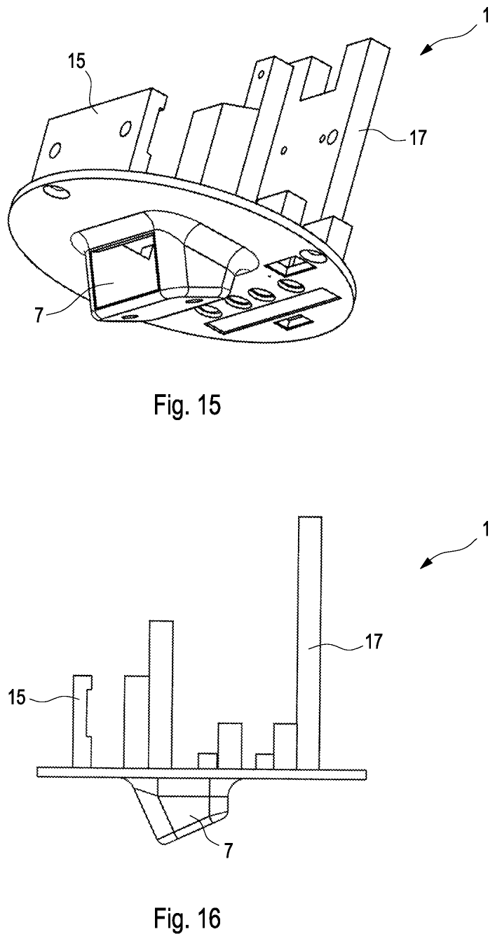

FIG. 15 shows a part of the scanner 1 with the reading unit 7.

FIG. 16 shows the part of the scanner 1 with the reading unit 7, wherein in addition the LED circuit board 15 and the rechargeable battery 17, i.e. the energy store, are illustrated schematically.

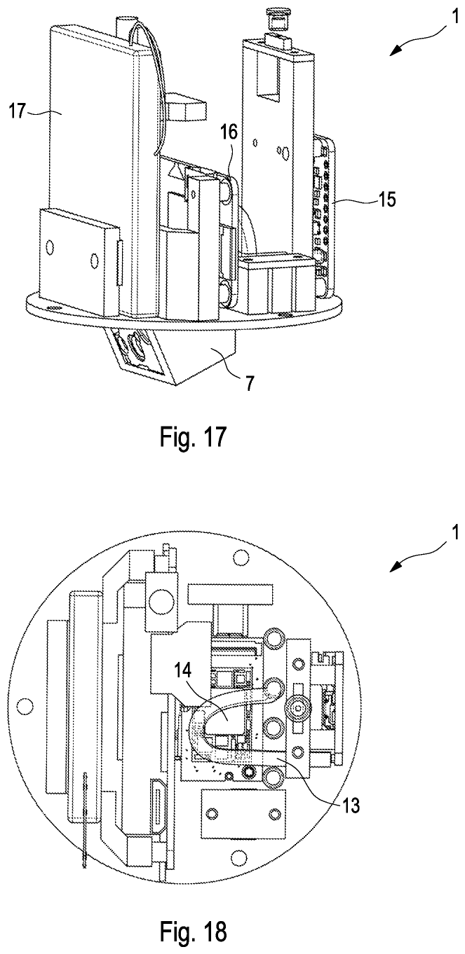

FIG. 17 shows the part of the scanner 1 with the reading unit 7 in a lateral perspective illustration. In addition, the LED circuit board 15, the rechargeable battery 17 and the circuit board for the charging management of the rechargeable battery 16 are illustrated schematically.

FIG. 18 shows the part of the scanner 1 in a view from above, wherein a light strip guide 13 and a mini-PC 14 are additionally depicted.

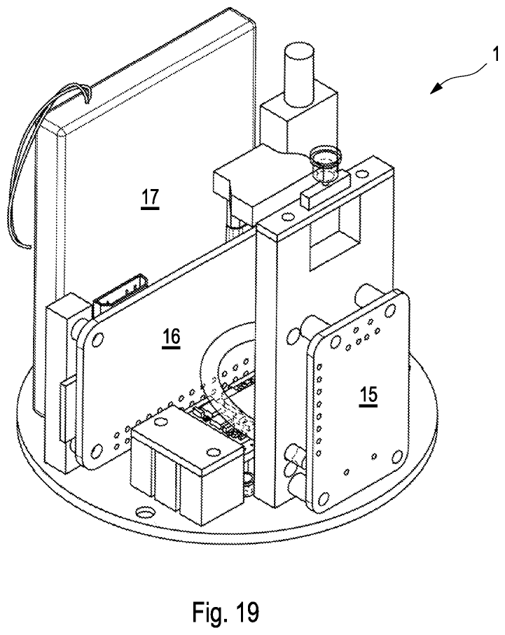

FIG. 19 shows the part of the scanner 1 in a perspective view from above. The rechargeable battery 17, the circuit board for the charging management of the rechargeable battery 16 and the LED circuit board 15, are additionally depicted.

In a further embodiment, the scanner protrudes forward in a straight line. An inclination is not necessary in this case.

The shape of this further embodiment is substantially cylindrical. In this case, the scanner is formed in particular from two stepped cylindrical sections arranged one above the other. The upper section has approximately a diameter of approximately 90 mm, and the lower section a diameter of approximately 76 mm. The total height of the scanner is approximately 45 mm in this case. The height of the lower section has a height of approximately 25 mm, and the upper section thus has a height of approximately 20 mm. This flatter embodiment is more advantageous and finds improved use.

In the region of the actual reading unit, the scanner is not embodied in a circular fashion, but rather in a straight fashion. The scanner can thus be inserted forward in a straight line. This facilitates ease of operation.

A grooving of the surface particularly on the cylindrical side walls is advantageous. Particularly in the upper section, a grooving with short spacings is provided symmetrically. The spacing of the preferably likewise symmetrical grooving in the lower section of the scanner has larger spacings between individual elevations. These groovings enable the scanner to be better rotated on the cart.

Furthermore, a rechargeable battery having a lengthened lifetime is used. A run time of up to approximately 9 hours is possible.

The following color selection has proved to be advantageous for the LED display of the scanner states:
blue: basic state, ready for connection to a transmitter, e.g. a mobile telephone,
flashing blue: the data connection to the transmitter is being established,
green: the connection has been established,
flashing green: the data are being scanned,
red or flashing red: the rechargeable battery power is weak.

It should be noted that the term “comprise” does not exclude further elements or method steps, and the term “a/an” and “one” likewise does not exclude a plurality of elements and steps.

The reference signs used serve merely to increase understandability and should in no way be regarded as restrictive, the scope of protection of the invention being rendered by the claims.

### LIST OF REFERENCE SIGNS

1 Scanner
2 Smartphone, cell phone
3 Shopping cart or transport cart
4 Product to be bought, or a packaging of a product
5 Push handle unit of a shopping cart
6 Object holder for a magnifying glass
7 Reading unit
8 Luminous display
9 Luminous display
10 End piece
11 Gripping unit
12 Display unit
13 Light strip guide
14 Mini-PC
15 LED circuit board
16 Circuit board for the charging management of the rechargeable battery
17 Rechargeable battery

1. A push handle unit of a shopping cart having at least one first and one second end piece, wherein a free-standing, upwardly projecting gripping unit is arranged on at least one end piece, wherein the gripping unit is configured as an object holder for receiving at least one beverage cup and/or a scanner and/or a magnifying glass for magnifying text on a packaging and/or a handle cap and/or a smartphone.

2. A push handle unit having at least one first and one second end piece (10), wherein a free-standing, upwardly projecting gripping unit is arranged on at least one end piece, wherein the gripping unit is configured as an object holder for receiving at least one beverage cup or a scanner or a magnifying glass or a handle cap or a smartphone.

3. The push handle unit as claimed in claim 1, wherein a display unit for identifying a successful scanning process, by way of a color change, is arranged on the scanner.

4. The push handle unit as claimed in claim 3, wherein the push handle unit comprises a luminous display, wherein the luminous display is shaped in the manner of an arrow, wherein the arrow is configured so as to be pointing in the direction of a scanning region.

5. The push handle unit as claimed in claim 1, wherein the push handle unit is configured with a magnifying glass in a first state and the magnifying glass is replaceable or is replaced by a scanner in a second state.

6. The push handle unit as claimed in claim 4, wherein the scanner comprises a reading unit facing toward the shopping cart, thus resulting in the scanning region being in the direction of the shopping cart.

7. The push handle unit as claimed in claim 1, wherein the smartphone and the scanner are connected to one another via WLAN or Bluetooth.

8. A shopping cart having a push handle unit as claimed in claim 1.

9. A method for communication between a scanner of a push handle unit according to claim 1 and a network and/or a smartphone.

10. A computer program product comprising a software program for realizing a device for scanning packagings and for communication with a network and/or a smartphone, wherein the computer program product comprises a set having instructions that cause the method as claimed in claim 9 to be carried out.
